(19) United States
(12) Patent Application Publication
(10) Pub. No.: US 2013/0268955 A1
(43) Pub. Date: Oct. 10, 2013

(54) HIGHLIGHTING OR AUGMENTING A MEDIA PROGRAM

(71) Applicants: Michael J. Conrad, Monroe, WA (US); Geoffrey J. Hulten, Lynnwood, WA (US); Kyle J. Krum, Sammamish, WA (US); Umaimah A. Mendhro, San Francisco, CA (US); Darren B. Remington, Sammamish, WA (US)

(72) Inventors: Michael J. Conrad, Monroe, WA (US); Geoffrey J. Hulten, Lynnwood, WA (US); Kyle J. Krum, Sammamish, WA (US); Umaimah A. Mendhro, San Francisco, CA (US); Darren B. Remington, Sammamish, WA (US)

(73) Assignee: MICROSOFT CORPORATION, Redmond, WA (US)

(21) Appl. No.: 13/441,228

(22) Filed: Apr. 6, 2012

(51) Int. Cl. H04N 21/258

(52) U.S. Cl. 725/12

(57) ABSTRACT

This document describes techniques and apparatuses for highlighting or augmenting a media program. The techniques and apparatuses can build a media program highlighting another media program based on media reactions to portions of that other media program. The techniques and apparatuses may also or instead augment a media program based on media reactions to portions of that media program.

### BACKGROUND

If a user is interested in enjoying media with other people, he or she may call over friends or go to a concert or theater. Calling over friends, however, may not be possible due to time constraints or some of the friends may have already enjoyed the media, as is more and more often the case due to the increasing ability to enjoy media at different times, such as with streaming media, digital video recorders, and so forth. Further, going to a concert or theater can be impractical for the user, as concerts and theaters generally are scheduled at particular set times, may require travel, and so forth.

If instead a user is interested in finding a media program that he or she is likely to enjoy, he or she may research online and newspaper reviews, ask friends, and consult personalized ratings services. Each of these approaches, however, has limitations, such as reviewers having different tastes than those of the user, friends having forgotten their impression or not yet having watched the media, and ratings services being overly simplistic or inaccurate.

### SUMMARY

This document describes techniques and apparatuses for highlighting or augmenting a media program. The techniques and apparatuses can build a media program highlighting another media program based on media reactions to portions of that other media program. In some embodiments, for example, the techniques can build a ten-minute program of highlights out of portions of a four-hour football game based on reactions of fans to that football game. A user may watch this ten-minute program of highlights to decide whether or not to watch the four-hour football game or enjoy the highlights on their own, thereby enjoying much of the football game without having to watch the whole game. The techniques and apparatuses may instead augment a media program based on media reactions to portions of that media program. In some embodiments, for example, the techniques may augment a half-hour comedy show with other people's reactions, such as a friend's laughter from when the friend previously watched the same comedy show.

This summary is provided to introduce simplified concepts for highlighting or augmenting a media program, which is further described below in the Detailed Description. This summary is not intended to identify essential features of the claimed subject matter, nor is it intended for use in determining the scope of the claimed subject matter.

### BRIEF DESCRIPTION OF THE DRAWINGS

Embodiments of techniques and apparatuses for highlighting or augmenting a media program are described with reference to the following drawings. The same numbers are used throughout the drawings to reference like features and components:

FIG. 1 illustrates an example environment in which techniques for highlighting or augmenting a media program can be implemented, as well as other techniques.

FIG. 2 is an illustration of an example computing device that is local to the audience of FIG. 1.

FIG. 3 is an illustration of an example remote computing device that is remote to the audience of FIG. 1.

FIG. 4 illustrates example methods for determining media reactions based on passive sensor data.

FIG. 5 illustrates a time-based graph of media reactions, the media reactions being interest levels for one user and for forty time periods during presentation of a media program.

FIG. 6 illustrates example methods for building a reaction history.

FIG. 7 illustrates example methods for highlighting a media program by building a media program using portions of the media program being highlighted.

FIG. 8 illustrates example methods for augmenting a media program with prior media reactions.

FIG. 9 illustrates a reaction graph showing average media reactions for a user's friends over thirty-one portions of a media program.

FIG. 10 illustrates example methods for enabling a selection to display a media reaction along with the portion of a media program.

FIG. 11 illustrates an example device in which techniques for highlighting or augmenting a media program, as well as other techniques, can be implemented.

### DETAILED DESCRIPTION

### Overview

This document describes techniques and apparatuses for highlighting or augmenting a media program. These techniques and apparatuses can highlight or augment a media program based on media reactions determined for other persons, such as large audiences, demographic groups, or friends associated with a user requesting the highlights or augmentation.

Consider, for example, a situational comedy program that has been presented to millions of people in a first time zone, such as Eastern Time in the United States. Assume that a user wishes to determine whether or not he is interested in watching the comedy about an hour after it was first aired in the Eastern Time zone. He can request highlights of the comedy in various ways, such as highlights based on a similar demographic group as himself (e.g., men aged 44-52), a group selected based on having similar tastes as he, highlights generally, or friends of his, such as friends in a social-networking service. The techniques may then build a media program of highlights with portions of the comedy, such as a two-minute program highlighting the 23-minute comedy (without commercials) based on people in the group laughing or smiling during those scenes. After watching the two-minute program the user may select to watch the whole show. Or he may forgo watching the whole show because he feels that he got most of the fun parts, he has seen enough to talk about the show with others the next day at work, or because he didn't like the program.

Consider also a user that was unable to watch a basketball game when it was aired live. Assume that the user enjoys watching sports with other fans, but his friends already watched the basketball game. In such a case, the techniques enable the user to request augmenting the basketball game with media reactions of other people. These media reactions can be from fans of both teams, fans of just his team, or his friends. Here assume that the user selects to augment the basketball game with fans of his team. The techniques determine which media reactions to use to augment the basketball game, such as audio having cheers and yelling at corresponding portions of the basketball game and displaying avatars for some of the physically expressive fans, thereby showing them jumping up and down and so forth. The user may now watch the basketball game and feel the effect of the game on other fans, thereby improving his experience of the game.

These are but two examples of how techniques and/or apparatuses highlight or augment a media program, though many others are contemplated herein. Techniques and/or apparatuses are referred to herein separately or in conjunction as the “techniques” as permitted by the context. This document now turns to an example environment in which the techniques can be embodied and then various example methods that can, but are not required to, work in conjunction with the techniques. Some of these various methods include methods for sensing and determining reactions to media and building a reaction history for a user. After these various methods, this document turns to example methods for highlighting or augmenting a media program.

Example Environment

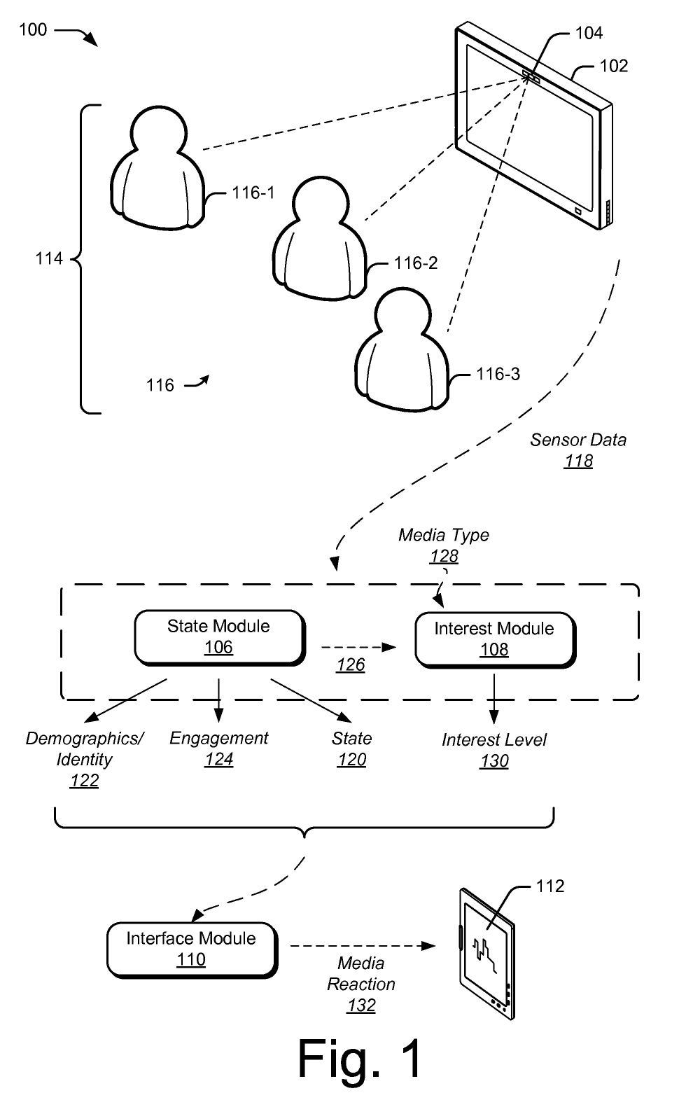

FIG. 1 is an illustration of an example environment 100 for receiving sensor data and determining media reactions based on this sensor data. These media reactions can be used to highlight or augment a media program, as well as other uses. The techniques may use these media reactions alone or in combination with other information, such as demographics, reaction histories, and information about the people and media program or portion thereof.

Environment 100 includes a media presentation device 102, an audience-sensing device 104, a state module 106, an interest module 108, an interface module 110, and a user interface 112.

Media presentation device 102 presents a media program to an audience 114 having one or more users 116. A media program can include, alone or in combination, a television show, a movie, a music video, a video clip, an advertisement, a blog, a photograph, a web page, an e-magazine, an e-book, a computer game, a song, a tweet, or other audio and/or video media. Audience 114 can include one or more users 116 that are in locations enabling consumption of a media program presented by media presentation device 102 and measurement by audience-sensing device 104, whether separately or within one audience 114. In audience 114 three users are shown: user 116-1, user 116-2, and user 116-3. While only three users are shown sensor data can be sensed and media reactions determined at many locations and for tens, hundreds, thousands, or even millions of users.

Audience-sensing device 104 is capable of sensing audience 114 and providing sensor data for audience 114 to state module 106 and/or interest module 108 (sensor data 118 shown provided via an arrow). The data sensed can be sensed passively, actively, and/or responsive to an explicit request.

Passively sensed data is passive by not requiring active participation of users in the measurement of those users. Actively sensed data includes data recorded by users in an audience, such as with handwritten logs, and data sensed from users through biometric sensors worn by users in the audience. Sensor data sensed responsive to an explicit request can be sensed actively or passively. One example is an advertisement that requests, during the advertisement, that a user raises his or her hand if he or she would like a coupon for a free sample of a product to be sent to the user by mail. In such a case, the user is expressing a reaction of raising a hand, though this can be passively sensed by not requiring the user to actively participate in the measurement of the reaction. The techniques sense this raised hand in various manners as set forth below.

Sensor data can include data sensed using emitted light or other signals sent by audience-sensing device 104, such as with an infrared sensor bouncing emitted infrared light off of users or the audience space (e.g., a couch, walls, etc.) and sensing the light that returns. Examples of sensor data measuring a user and ways in which it can be measured are provided in greater detail below.

Audience-sensing device 104 may or may not process sensor data prior to providing it to state module 106 and/or interest module 108. Thus, sensor data may be or include raw data or processed data, such as: RGB (Red, Green, Blue) frames; infrared data frames; depth data; heart rate; respiration rate; a user's head orientation or movement (e.g., coordinates in three dimensions, x, y, z, and three angles, pitch, tilt, and yaw); facial (e.g., eyes, nose, and mouth) orientation, movement, or occlusion; skeleton's orientation, movement, or occlusion; audio, which may include information indicating orientation sufficient to determine from which user the audio originated or directly indicating which user, or what words were said, if any; thermal readings sufficient to determine or indicating presence and locations of one of users 116; and distance from the audience-sensing device 104 or media presentation device 102. In some cases audience-sensing device 104 includes infrared sensors (webcams, Kinect cameras), stereo microphones or directed audio microphones, and a thermal reader (in addition to infrared sensors), though other sensing apparatuses may also or instead be used.

State module 106 receives sensor data and determines, based on the sensor data, states 120 of users 116 in audience 114 (shown at arrow). States include, for example: sad, talking, disgusted, afraid, smiling, scowling, placid, surprised, angry, laughing, screaming, clapping, waving, cheering, looking away, looking toward, leaning away, leaning toward, asleep, or departed, to name just a few.

The talking state can be a general state indicating that a user is talking, though it may also include subcategories based on the content of the speech, such as talking about the media program (related talking) or talking that is unrelated to the media program (unrelated talking). State module 106 can determine which talking category through speech recognition.

State module 106 may also or instead determine, based on sensor data, a number of users, a user's identity and/or demographic data (shown at 122), or engagement (shown at 124) during presentation. Identity indicates a unique identity for one of users 116 in audience 114, such as Susan Brown. Demographic data classifies one of users 116, such as 5 feet, 4 inches tall, young child, and male or female. Engagement indicates whether a user is likely to be paying attention to the media program, such as based on that user's presence or head orientation. Engagement, in some cases, can be determined by state module 106 with lower-resolution or less-processed sensor data compared to that used to determine states. Even so, engagement can be useful in measuring an audience, whether on its own or to determine a user's interest using interest module 108.

Interest module 108 determines, based on sensor data 118 and/or a user's engagement or state (shown with engagement/state 126 at arrow) and information about the media program (shown at media type 128 at arrow), that user's interest level 130 (shown at arrow) in the media program. Interest module 108 may determine, for example, that multiple laughing states for a media program intended to be a serious drama indicate a low level of interest and conversely, that for a media program intended to be a comedy, that multiple laughing states indicate a high level of interest.

As illustrated in FIG. 1, state module 106 and/or interest module 108 provide demographics/identity 122 as well as one or more of the following media reactions: engagement 124, state 120, or interest level 130, all shown at arrows in FIG. 1. Based on one or more of these media reactions, state module 106 and/or interest module 108 may also provide another type of media reaction, that of overall media reactions to a media program, such as a rating (e.g., thumbs up or three stars). In some cases, however, media reactions are received and overall media reactions are determined instead by interface module 110.

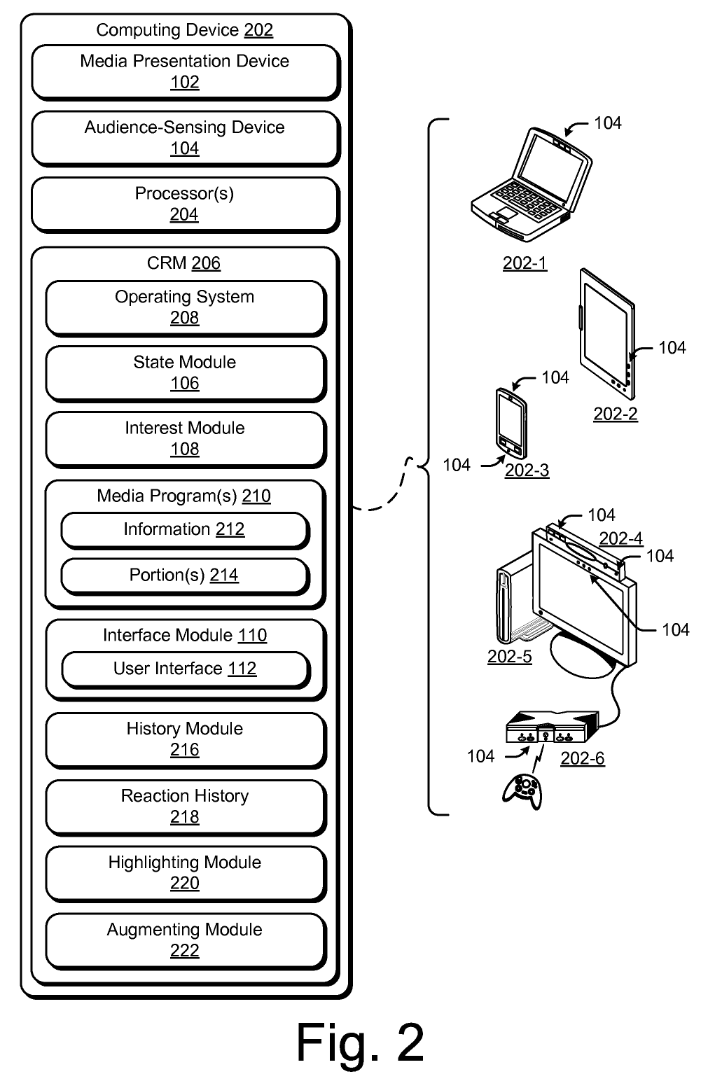

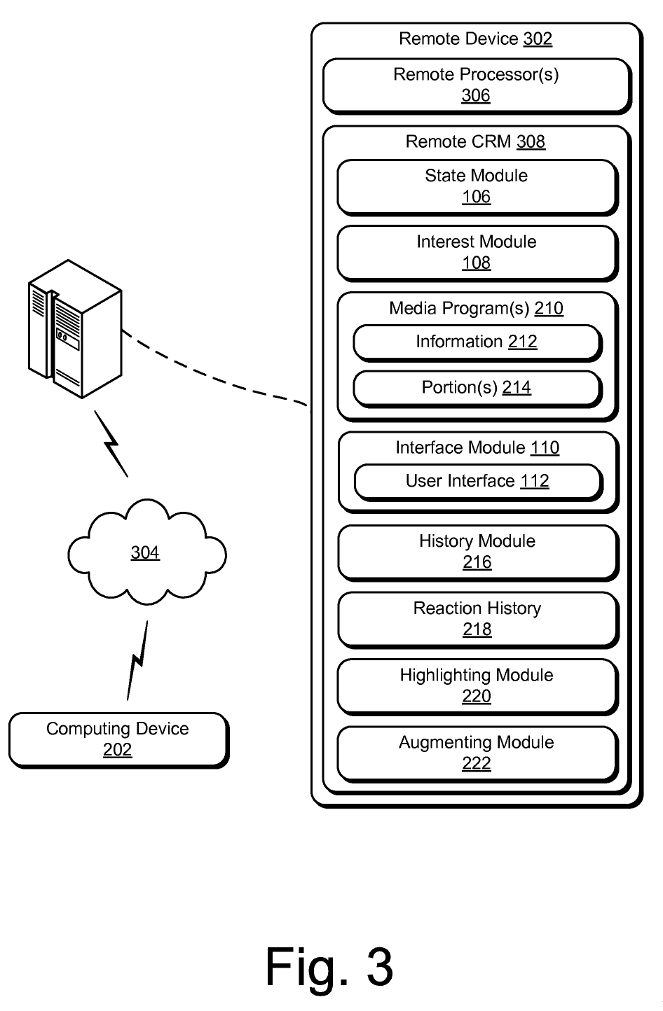

State module 106 and interest module 108 can be local to audience 114, and thus media presentation device 102 and audience-sensing device 104, though this is not required. An example embodiment where state module 106 and interest module 108 are local to audience 114 is shown in FIG. 2. In some cases, however, state module 106 and/or interest module 108 are remote from audience 114, which is illustrated in FIG. 3.

Interface module 110 receives media reactions and demographics/identity information, and determines or receives some indication as to which media program or portion thereof that the reactions pertain. Interface module 110 presents, or causes to be presented, a media reaction 132 to a media program through user interface 112, though this is not required. This media reaction can be any of the above-mentioned reactions, some of which are presented in a time-based graph, through an avatar showing the reaction, or a video or audio of the user recorded during the reaction, one or more of which is effective to how a user's reaction over the course of the associated media program.

Interface module 110 can be local to audience 114, such as in cases where one user is viewing his or her own media reactions or those of a family member. In many cases, however, interface module 110 receives media reactions from a remote source.

Note that sensor data 118 may include a context in which a user is reacting to media or a current context for a user for which ratings or recommendations for media are requested. Thus, audience-sensing device 104 may sense that a second person is in the room or is otherwise in physical proximity to the first person, which can be context for the first person. Contexts may also be determined in other manners described in FIG. 2 below.

FIG. 2 is an illustration of an example computing device 202 that is local to audience 114. Computing device 202 includes or has access to media presentation device 102, audience-sensing device 104, one or more processors 204, and computer-readable storage media (“CRM”) 206.

CRM 206 includes an operating system 208, state module 106, interest module 108, media program(s) 210, each of which may include or have associated program information 212 and portions 214, interface module 110, user interface 112, history module 216, reaction history 218, highlighting module 220, and augmenting module 222.

Each of media programs 210 may have, include, or be associated with program information 212 and portions 214. Program information 212 can indicate the name, title, episode, author or artist, type of program, and other information, including relating to various portions within each media program 210. Thus, program information 212 may indicate that one of media programs 210 is a music video, includes a chorus portion that is repeated four times, includes four verse portions, includes portions based on each visual presentation during the song, such as the artist singing, the backup singers dancing, the name of the music video, the artist, the year produced, resolution and formatting data, and so forth.

Portions 214 of one of media programs 210 make up the program and can be used to build another media program, such as a program highlighting one of media programs 210. These portions may represent particular time-ranges in the media program, though they may instead be located in the program based on a prior portion ending (even if the time at which that portion ending is not necessarily set in advance). Example portions may be 15-second-long pieces, a song being played in a radio-like program, a joke in a comedy, a possession or play in a sporting event, or a scene of a movie, to name a few.

History module 216 includes or has access to reaction history 218. History module 216 may build and update reaction history 218 based on ongoing reactions by the user (or others as noted below) to media programs. In some cases history module 216 determines various contexts for a user, though this may instead be determined and received from other entities. Thus, in some cases history module 216 determines a time, a locale, weather at the locale, and so forth, during the user's reaction to a media program or request for ratings or recommendations for a media program. History module 216 may determine ratings and/or recommendations for media based on a current context for a user and reaction history 218. Reaction history 218, as noted elsewhere herein, may be used along with media reactions to build a program of highlights or augment media programs.

Highlighting module 220 builds a media program using portions of another media program based on media reactions to the portions, such as fans cheering during a possession in a basketball game, laughing at a joke in a comedy, or dancing to a song.

Augmenting module 222 augments a media program with media reactions to the media program at the respective portions, such as audio of a person laughing at a joke, video of a person or avatar dancing to a song, or audio and video of a person cheering and jumping up and down at a goal in a soccer match.

Highlighting module 220 and augmenting module 222 may operate separate or in conjunction, and may be a single or multiple entities. For example, highlighting module 220 may build a highlight program having five suspenseful scenes of a thriller movie and augmenting module 222 may augment the highlight program with media reactions (screams, etc.) to those scenes.

Highlighting module 220 and/or augmenting module 222 may receive media reactions of a user, a group of users, or many users to a portion of one of media programs 210. These media reactions may include one or more of engagements 124, states 120, and interest levels 130. With these media reactions, highlighting module 220 may determine a portion to use to build a highlight program and/or augmenting module 222 may present the media reaction during presentation of that portion. As shown in FIGS. 2 and 3, media program 210, portions 214, highlighting module 220, and augmenting module 222 may be local or remote from computing device 202 and thus the user or users having the media reactions (e.g., user 116-1 of audience 114 of FIG. 1).

Note that in this illustrated example, entities including media presentation device 102, audience-sensing device 104, state module 106, interest module 108, interface module 110, history module 216, highlighting module 220, and augmenting module 222 are included within a single computing device, such as a desktop computer having a display, forward-facing camera, microphones, audio output, and the like. Each of these entities, however, may be separate from or integral with each other in one or multiple computing devices or otherwise. As will be described in part below, media presentation device 102 can be integral with audience-sensing device 104 but be separate from state module 106, interest module 108, interface module 110, history module 216, highlighting module 220, or augmenting module 222. Further, each of these modules may operate on separate devices or be combined in one device.

As shown in FIG. 2, computing device(s) 202 can each be one or a combination of various devices, here illustrated with six examples: a laptop computer 202-1, a tablet computer 202-2, a smart phone 202-3, a set-top box 202-4, a desktop 202-5, and a gaming system 202-6, though other computing devices and systems, such as televisions with computing capabilities, netbooks, and cellular phones, may also be used. Note that three of these computing devices 202 include media presentation device 102 and audience-sensing device 104 (laptop computer 202-1, tablet computer 202-2, smart phone 202-3). One device excludes but is in communication with media presentation device 102 and audience-sensing device 104 (desktop 202-5). Two others exclude media presentation device 102 and may or may not include audience-sensing device 104, such as in cases where audience-sensing device 104 is included within media presentation device 102 (set-top box 202-4 and gaming system 202-6).

FIG. 3 is an illustration of an example remote computing device 302 that is remote to audience 114. FIG. 3 also illustrates a communications network 304 through which remote computing device 302 communicates with audience-sensing device 104 (not shown, but embodied within, or in communication with, computing device 202), interface module 110, history module 216 (including or excluding reaction history 218), highlighting module 220, and augmenting module 222, assuming that these entities are in computing device 202 as illustrated in FIG. 2. Communication network 304 may be the Internet, a local-area network, a wide-area network, a wireless network, a USB hub, a computer bus, another mobile communications network, or a combination of these.

Remote computing device 302 includes one or more processors 306 and remote computer-readable storage media (“remote CRM”) 308. Remote CRM 308 includes state module 106, interest module 108, media program(s) 210, each of which may include or have associated program information 212 and/or portions 214, history module 216, reaction history 218, highlighting module 220, and augmenting module 222.

Note that in this illustrated example, media presentation device 102 and audience-sensing device 104 are physically separate from state module 106 and interest module 108, with the first two local to an audience viewing a media program and the second two operating remotely. Thus, sensor data is passed from audience-sensing device 104 to one or both of state module 106 or interest module 108, which can be communicated locally (FIG. 2) or remotely (FIG. 3). Further, after determination by state module 106 and/or interest module 108, various media reactions and other information can be communicated to the same or other computing devices 202 for receipt by interface module 110, history module 216, highlighting module 220, and/or augmenting module 222. Thus, in some cases a first of computing devices 202 may measure sensor data, communicate that sensor data to remote device 302, after which remote device 302 communicates media reactions to another of computing devices 202, all through network 304.

These and other capabilities, as well as ways in which entities of FIGS. 1-3 act and interact, are set forth in greater detail below. These entities may be further divided, combined, and so on. The environment 100 of FIG. 1 and the detailed illustrations of FIGS. 2 and 3 illustrate some of many possible environments capable of employing the described techniques.

Example Methods

Determining Media Reactions Based on Passive Sensor Data

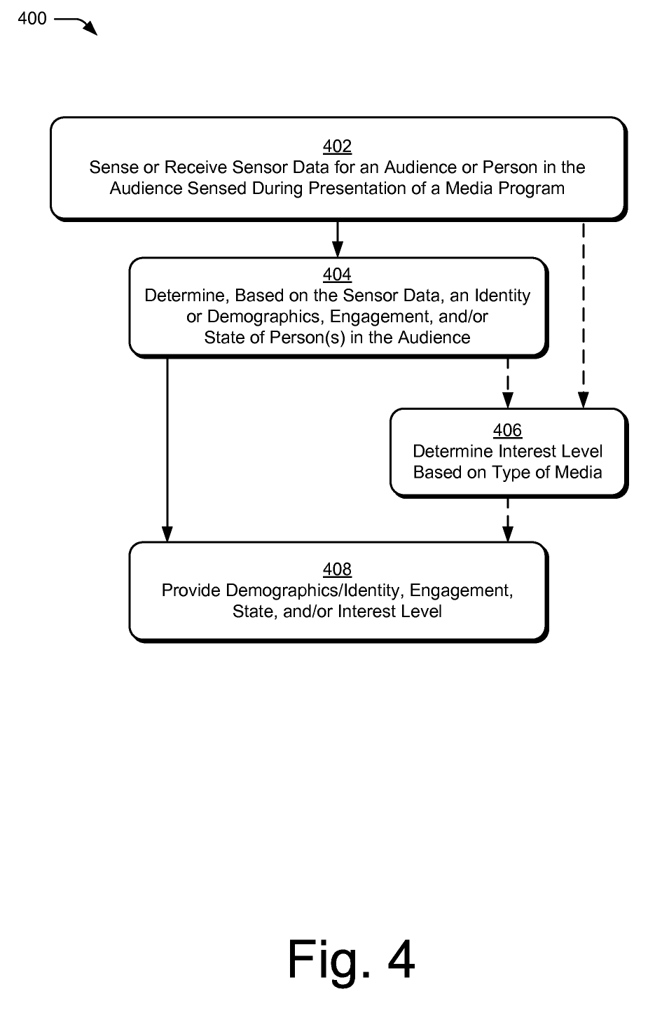

FIG. 4 depicts methods 400 determines media reactions based on passive sensor data. These and other methods described herein are shown as sets of blocks that specify operations performed but are not necessarily limited to the order shown for performing the operations by the respective blocks. In portions of the following discussion reference may be made to environment 100 of FIG. 1 and entities detailed in FIGS. 2-3, reference to which is made for example only. The techniques are not limited to performance by one entity or multiple entities operating on one device.

Block 402 senses or receives sensor data for an audience or user, the sensor data passively sensed during presentation of a media program to the audience or user. This sensor data may include a context of the audience or user or a context may be received separately.

Consider, for example, a case where an audience includes three users 116, users 116-1, 116-2, and 116-3 all of FIG. 1. Assume that media presentation device 102 is an LCD display having speakers and through which the media program is rendered and that the display is in communication with set-top box 202-4 of FIG. 2. Here audience-sensing device 104 is a Kinect, forward-facing high-resolution infrared sensor, a red-green-blue sensor and two microphones capable of sensing sound and location that is integral with set-top box 202-4 or media presentation device 102. Assume also that the media program 210 being presented is a PG-rated animated movie named Incredible Family, which is streamed from a remote source and through set-top box 202-4. Set-top box 202-4 presents Incredible Family with six advertisements, spaced one at the beginning of the movie, three in a three-ad block, and two in a two-ad block.

Sensor data is received for all three users 116 in audience 114; for this example consider first user 116-1. Assume here that, over the course of Incredible Family, that audience-sensing device 104 measures, and then provides at block 402, the following at various times for user 116-1:
Time 1, head orientation 3 degrees, no or low-amplitude audio.
Time 2, head orientation 24 degrees, no audio.
Time 3, skeletal movement (arms), high-amplitude audio.
Time 4, skeletal movement (arms and body), high-amplitude audio.
Time 5, head movement, facial-feature change (20%), moderate-amplitude audio.
Time 6, detailed facial orientation data, no audio.
Time 7, skeletal orientation (missing), no audio.
Time 8, facial orientation, respiration rate.

Block 404 determines, based on the sensor data, a state of the user during the media program. In some cases block 404 determines a probability for the state or multiple probabilities for multiple states, respectively. For example, block 404 may determine a state likely to be correct but with less than full certainty (e.g., 40% chance that the user is laughing). Block 404 may also or instead determine that multiple states are possible based on the sensor data, such as a sad or placid state, and probabilities for each (e.g., sad state 65%, placid state 35%).

Block 404 may also or instead determine demographics, identity, and/or engagement. Further, methods 400 may skip block 404 and proceed directly to block 406, as described later below.

In the ongoing example, state module 106 receives the above-listed sensor data and determines the following corresponding states for user 116-1:
Time 1: Looking toward.
Time 2: Looking away.
Time 3: Clapping.
Time 4: Cheering.
Time 5: Laughing.
Time 6: Smiling.
Time 7: Departed.
Time 8: Asleep.

At Time 1 state module 106 determines, based on the sensor data indicating a 3-degree deviation of user 116-1's head from looking directly at the LCD display and a rule indicating that the looking toward state applies for deviations of less than 20 degrees (by way of example only), that user 116-1's state is looking toward the media program. Similarly, at Time 2, state module 106 determines user 116-1 to be looking away due to the deviation being greater than 20 degrees.

At Time 3, state module 106 determines, based on sensor data indicating that user 116-1 has skeletal movement in his arms and audio that is high amplitude that user 116-1 is clapping. State module 106 may differentiate between clapping and other states, such as cheering, based on the type of arm movement (not indicated above for brevity). Similarly, at Time 4, state module 106 determines that user 116-1 is cheering due to arm movement and high-amplitude audio attributable to user 116-1.

At Time 5, state module 106 determines, based on sensor data indicating that user 116-1 has head movement, facial-feature changes of 20%, and moderate-amplitude audio, that user 116-1 is laughing. Various sensor data can be used to differentiate different states, such as screaming, based on the audio being moderate-amplitude rather than high-amplitude and the facial-feature changes, such as an opening of the mouth and a rising of both eyebrows.

For Time 6, audience-sensing device 104 processes raw sensor data to provide processed sensor data, and in this case facial recognition processing to provide detailed facial orientation data. In conjunction with no audio, state module 106 determines that the detailed facial orientation data (here upturned lip corners, amount of eyelids covering eyes) that user 116-1 is smiling.

At Time 7, state module 106 determines, based on sensor data indicating that user 116-1 has skeletal movement moving away from the audience-sensing device 104, that user 116-1 is departed. The sensor data may indicate this directly as well, such as in cases where audience-sensing device 104 does not sense user 116-1's presence, either through no skeletal or head readings or a thermal signature no longer being received.

At Time 8, state module 106 determines, based on sensor data indicating that user 116-1's facial orientation has not changed over a certain period (e.g., the user's eyes have not blinked) and a steady, slow respiration rate that user 116-1 is asleep.

These eight sensor readings are simplified examples for purpose of explanation. Sensor data may include extensive data as noted elsewhere herein. Further, sensor data may be received measuring an audience every fraction of a second, thereby providing detailed data for tens, hundreds, and thousands of periods during presentation of a media program and from which states or other media reactions may be determined.

Returning to methods 400, block 404 may determine demographics, identity, and engagement in addition to a user's state. State module 106 may determine or receive sensor data from which to determine demographics and identity or receive, from audience-sensing device 104, the demographics or identity. Continuing the ongoing example, the sensor data for user 116-1 may indicate that user 116-1 is John Brown, that user 116-2 is Lydia Brown, and that user 116-3 is Susan Brown. Or sensor data may indicate that user 116-1 is six feet, four inches tall and male (based on skeletal orientation), for example. The sensor data may be received with or include information indicating portions of the sensor data attributable separately to each user in the audience. In this present example, however, assume that audience-sensing device 104 provides three sets of sensor data, with each set indicating the identity of the user along with the sensor data.

Also at block 404, the techniques may determine an engagement of an audience or user in the audience. As noted, this determination can be less refined than that of states of a user, but nonetheless is useful. Assume for the above example, that sensor data is received for user 116-2 (Lydia Brown), and that this sensor data includes only head and skeletal orientation:
Time 1, head orientation 0 degrees, skeletal orientation upper torso forward of lower torso.
Time 2, head orientation 2 degrees, skeletal orientation upper torso forward of lower torso.
Time 3, head orientation 5 degrees, skeletal orientation upper torso approximately even with lower torso.
Time 4, head orientation 2 degrees, skeletal orientation upper torso back from lower torso.
Time 5, head orientation 16 degrees, skeletal orientation upper torso back from lower torso.
Time 6, head orientation 37 degrees, skeletal orientation upper torso back from lower torso.
Time 7, head orientation 5 degrees, skeletal orientation upper torso forward of lower torso.
Time 8, head orientation 1 degree, skeletal orientation upper torso forward of lower torso.

State module 106 receives this sensor data and determines the following corresponding engagement for Lydia Brown:
Time 1: Engagement High.
Time 2: Engagement High.
Time 3: Engagement Medium-High.
Time 4: Engagement Medium.
Time 5: Engagement Medium-Low.
Time 6: Engagement Low.
Time 7: Engagement High.
Time 8: Engagement High.

At Times 1, 2, 7, and 8, state module 106 determines, based on the sensor data indicating a 5-degree-or-less deviation of user 116-2's head from looking directly at the LCD display and skeletal orientation of upper torso forward of lower torso (indicating that Lydia is leaning forward to the media presentation) that Lydia is highly engaged in Incredible Family at these times.

At Time 3, state module 106 determines that Lydia's engagement level has fallen due to Lydia no longer leaning forward. At Time 4, state module 106 determines that Lydia's engagement has fallen further to medium based on Lydia leaning back, even though she is still looking almost directly at Incredible Family.

At Times 5 and 6, state module 106 determines Lydia is less engaged, falling to Medium-Low and then Low engagement based on Lydia still leaning back and looking slightly away (16 degrees) and then significantly away (37 degrees), respectively. Note that at Time 7 Lydia quickly returns to a High engagement, which media creators are likely interested in, as it indicates content found to be exciting or otherwise captivating.

Methods 400 may proceed directly from block 402 to block 406, or from block 404 to block 406 or block 408. If proceeding to block 406 from block 404, the techniques determine an interest level based on the type of media being presented and the user's engagement or state. If proceeding to block 406 from block 402, the techniques determine an interest level based on the type of media being presented and the user's sensor data, without necessarily first or independently determining the user's engagement or state.

Continuing the above examples for users 116-1 and 116-2, assume that block 406 receives states determined by state module 106 at block 404 for user 116-1 (John Brown). Based on the states for John Brown and information about the media program, interest module 108 determines an interest level, either overall or over time, for Incredible Family. Assume here that Incredible Family is both an adventure and a comedy program, with portions of the movie marked as having one of these media types. While simplified, assume that Times 1 and 2 are marked as comedy, Times 3 and 4 are marked as adventure, Times 5 and 6 are marked as comedy, and that Times 7 and 8 are marked as adventure. Revisiting the states determined by state module 106, consider the following again:
Time 1: Looking toward.
Time 2: Looking away.
Time 3: Clapping.
Time 4: Cheering.
Time 5: Laughing.
Time 6: Smiling.
Time 7: Departed.
Time 8: Asleep.

Based on these states, state module 106 determines for Time 1 that John Brown has a medium-low interest in the content at Time 1—if this were of an adventure or drama type, state module 106 may determine John Brown to instead be highly interested. Here, however, due to the content being comedy and thus intended to elicit laughter or a similar state, interest module 108 determines that John Brown has a medium-low interest at Time 1. Similarly, for Time 2, interest module 108 determines that John Brown has a low interest at Time 2 because his state is not only not laughing or smiling but is looking away.

At Times 3 and 4, interest module 108 determines, based on the adventure type for these times and states of clapping and cheering, that John Brown has a high interest level. At time 6, based on the comedy type and John Brown smiling, that he has a medium interest at this time.

At Times 7 and 8, interest module 108 determines that John Brown has a very low interest. Here the media type is adventure, though in this case interest module 108 would determine John Brown's interest level to be very low for most types of content.

As can be readily seen, advertisers, media providers, builders or augmenters of media, and media creators can benefit from knowing a user's interest level. Here assume that the interest level is provided over time for Incredible Family, along with demographic information about John Brown. With this information from numerous demographically similar users, a media creator may learn that male adults are interested in some of the adventure content but that most of the comedy portions are not interesting, at least for this demographic group.

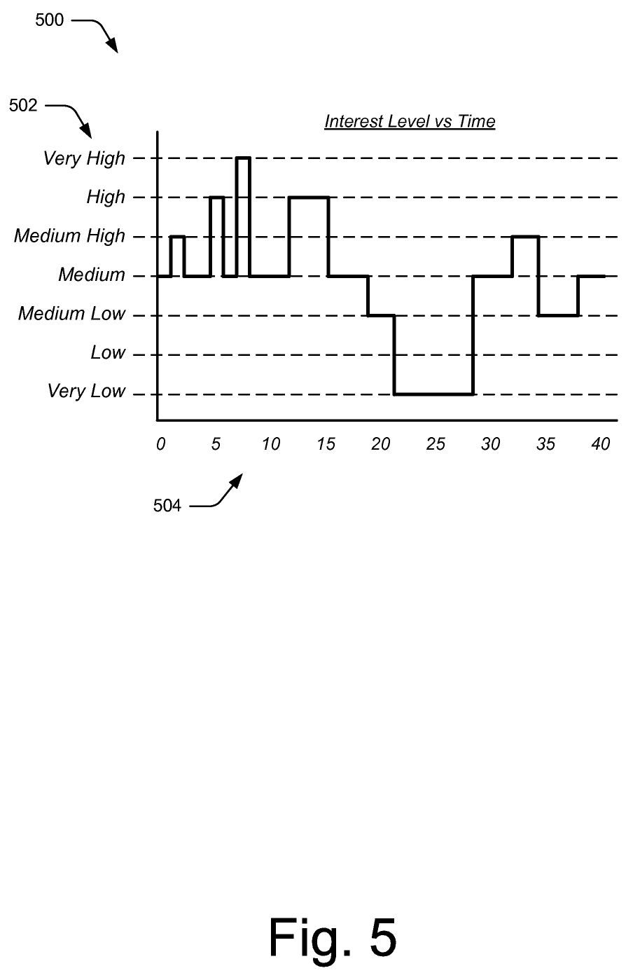

Consider, by way of a more-detailed example, FIG. 5, which illustrates a time-based graph 500 having interest levels 502 for forty time periods 504 over a portion of a media program. Here assume that the media program is a movie that includes other media programs—advertisements—at time periods 18 to 30. Interest module 108 determines, as shown, that the user begins with a medium interest level, and then bounces between medium and medium-high, high, and very high interest levels to time period 18. During the first advertisement, which covers time periods 18 to 22, interest module 108 determines that the user has a medium low interest level. For time periods 23 to 28, however, interest module 108 determines that the user has a very low interest level (because he is looking away and talking or left the room, for example). For the last advertisement, which covers time period 28 to 32, however, interest module 108 determines that the user has a medium interest level for time periods 29 to 32—most of the advertisement.

This can be valuable information—the user stayed for the first advertisement, left for the middle advertisement and the beginning of the last advertisement, and returned, with medium interest, for most of the last advertisement. Contrast this resolution and accuracy of interest with some conventional approaches, which likely would provide no information about how many of the people that watched the movie actually watched the advertisements, which ones, and with what amount of interest. If this example is a common trend with the viewing public, prices for advertisements in the middle of a block would go down, and other advertisement prices would be adjusted as well. Or, advertisers and media providers might learn to play shorter advertisement blocks having only two advertisements, for example. Interest levels 502 also provide valuable information about portions of the movie itself, such as through the very high interest level at time period 7 (e.g., a particularly captivating scene of a movie) and the waning interest at time periods 35-38.

Note that, in some cases, engagement levels, while useful, may be less useful or accurate than states and interest levels. For example, state module 106 may determine, for just engagement levels, that a user is not engaged if the user's face is occluded (blocked) and thus not looking at the media program. If the user's face is blocked by that user's hands (skeletal orientation) and audio indicates high-volume audio, state module 106, when determining states, may determine the user to be screaming. A screaming state indicates, in conjunction with the content being horror or suspense, an interest level that is very high. This is but one example of where an interest level can be markedly different from that of an engagement level.

As noted above, methods 400 may proceed directly from block 402 to block 406. In such a case, interest module 108, either alone or in conjunction with state module 106, determines an interest level based on the type of media (including multiple media types for different portions of a media program) and the sensor data. By way of example, interest module 108 may determine that for sensor data for John Brown at Time 4, which indicates skeletal movement (arms and body), and high-amplitude audio, and a comedy, athletics, conflict-based talk show, adventure-based video game, tweet, or horror types, that John Brown has a high interest level at Time 4. Conversely, interest module 108 may determine that for the same sensor data at Time 4 for a drama, melodrama, or classical music, that John Brown has a low interest level at Time 4. This can be performed based on the sensor data without first determining an engagement level or state, though this may also be performed.

Block 408, either after block 404 or 406, provides the demographics, identity, engagement, state, and/or interest level. State module 106 or interest module 108 may provide this information to various entities, such as interface module 110, history module 216, highlighting module 220, and/or augmenting module 222, as well as others.

Providing this information to highlighting module 220 enables highlighting module 220 to build a program with portions that are actual highlights, such as a well-received joke in a comedy or an amazing sports play in a sporting program. Providing this information to augmenting module 222 enables augmenting module 222 to add media reactions to a presentation of a media program, which may improve the experience for a user. A user may enjoy a comedy more when accompanied with real laughter and at correct times in a comedy program, for example, as compared to a laugh track.

Providing this information to an advertiser after presentation of an advertisement in which a media reaction is determined can be effective to enable the advertiser to measure a value of their advertisements shown during a media program. Providing this information to a media creator can be effective to enable the media creator to assess a potential value of a similar media program or portion thereof. For example, a media creator, prior to releasing the media program to the general public, may determine portions of the media program that are not well received, and thus alter the media program to improve it.

Providing this information to a rating entity can be effective to enable the rating entity to automatically rate the media program for the user. Still other entities, such as a media controller, may use the information to improve media control and presentation. A local controller may pause the media program responsive to all of the users in the audience departing the room, for example.

Providing media reactions to history module 216 can be effective to enable history module 216 to build and update reaction history 218. History module 216 may build reaction history 218 based on a context or contexts in which each set of media reactions to a media program are received, or the media reactions may, in whole or in part, factor in a context into the media reactions. Thus, a context for a media reaction where the user is watching a television show on a Wednesday night after work may be altered to reflect that the user may be tired from work.

As noted herein, the techniques can determine numerous states for a user over the course of most media programs, even for 15-second advertisements or video snippets. In such a case block 404 is repeated, such as at one-second periods.

Furthermore, state module 106 may determine not only multiple states for a user over time, but also various different states at a particular time. A user may be both laughing and looking away, for example, both of which are states that may be determined and provided or used to determine the user's interest level.

Further still, either or both of state module 106 and interest module 108 may determine engagement, states, and/or interest levels based on historical data in addition to sensor data or media type. In one case a user's historical sensor data is used to normalize the user's engagement, states, or interest levels (e.g., dynamically for a current media reaction). If, for example, Susan Brown is viewing a media program and sensor data for her is received, the techniques may normalize or otherwise learn how best to determine engagement, states, and interest levels for her based on her historical sensor data. If Susan Brown's historical sensor data indicates that she is not a particularly expressive or vocal user, the techniques may adjust for this history. Thus, lower-amplitude audio may be sufficient to determine that Susan Brown laughed compared to amplitude of audio used to determine that a typical user laughed.

In another case, historical engagement, states, or interest levels of the user for which sensor data is received are compared with historical engagement, states, or interest levels for other people. Thus, a lower interest level may be determined for Lydia Brown based on data indicating that she exhibits a high interest for almost every media program she watches compared to other people's interest levels (either generally or for the same media program). In either of these cases the techniques learn over time, and thereby can normalize engagement, states, and/or interest levels.

Methods for Building a Reaction History

As noted above, the techniques may determine a user's engagement, state, and/or interest level for various media programs. Further, these techniques may do so using passive or active sensor data. With these media reactions, the techniques may build a reaction history for a user. This reaction history can be used in various manners as set forth elsewhere herein.

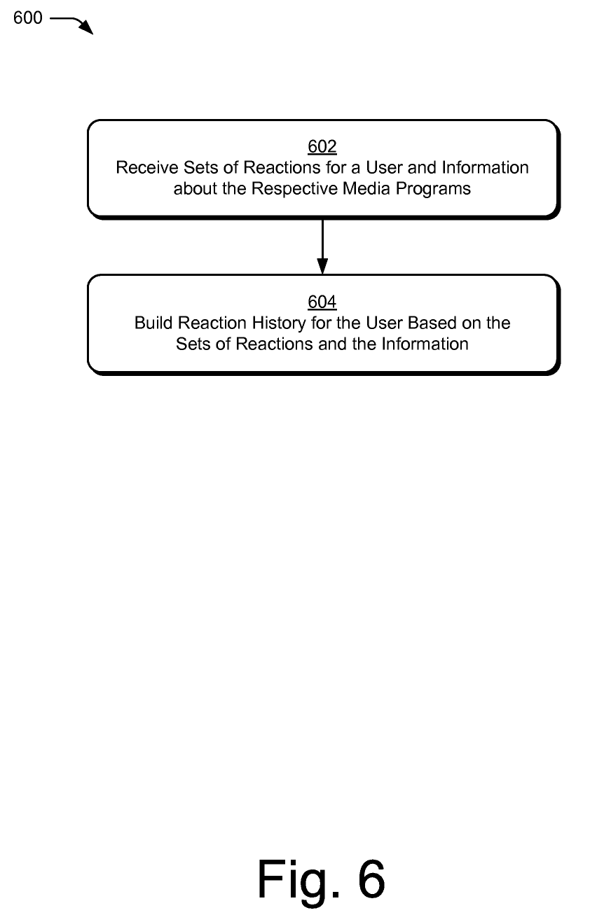

FIG. 6 depicts methods 600 for building a reaction history based on a user's reactions to media programs. Block 602 receives sets of reactions of a user, the sets of reactions sensed during presentation of multiple respective media programs, and information about the respective media programs. An example set of reactions to a media program is illustrated in FIG. 5, those shown being a measure of interest level over the time in which the program was presented to the user.

The information about the respective media programs can include, for example, the name of the media (e.g., The Office, Episode 104) and its type (e.g., a song, a television show, or an advertisement) as well as other information set forth herein.

In addition to the media reactions and their respective media programs, block 602 may receive a context for the user during which the media program was presented as noted above.

Further still, block 602 may receive media reactions from other users with which to build the reaction history. Thus, history module 216 may determine, based on the user's media reactions (either in part or after building an initial or preliminary reaction history for the user) other users having similar reactions to those of the user. History module 216 may determine other persons that have similar reactions to those of the user and use those other persons' reactions to programs that the user has not yet seen or heard to refine a reaction history for the user.

Block 604 builds a reaction history for the user based on sets of reactions for the user and information about the respective media programs. As noted, block 604 may also build the user's reaction history using other persons' reaction histories, contexts, and so forth. This reaction history can be used elsewhere herein to determine programs likely to be enjoyed by the user, advertisements likely to be effective when shown to the user, and for other purposes noted herein.

Methods for Highlighting a Media Program

As noted above, the techniques may build a media program with portions of another media program. The techniques may do so based on media reactions to those portions of the other media program, such as many users' engagements, states, and/or interest levels.

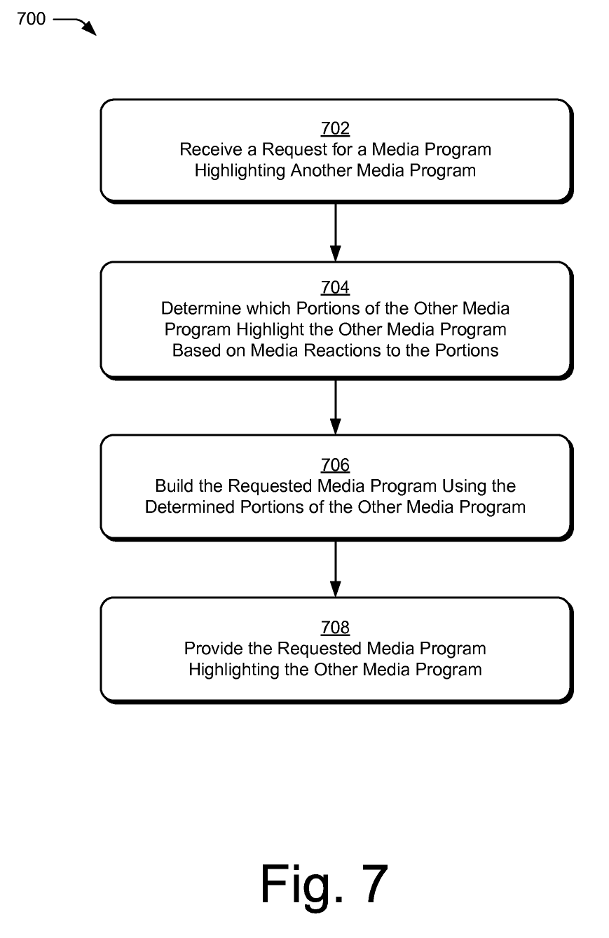

FIG. 7 depicts methods 700 for highlighting a media program using portions of the media program, the portions determined to be highlights of the media program based on media reactions to those portions.

Block 702 receives a request for a media program highlighting another media program. The request may indicate a particular program to be highlighted, or a type of program, a length of the highlights, and so forth.

This request may be received through a user interface, such as one that presents media programs for download. Assume that a user is attempting to find a movie to watch. The user may select that a media program highlighting each movie be presented, which in this case would be similar to a movie trailer but with the trailer tailored to the user based on media reactions of a group.

Assume that the user requests highlights for four movies, The Lord of the Rings, A Fist-Full of Dollars, A Room with a View, and The Godfather. Assume also that the user requests that the highlights be based on media reactions of a demographic group similar to the user, namely men aged 18-34 with a similar reaction history (e.g., liking action movies and crime dramas).

Block 704 determines which portions of the other media program are highlights of the other media program based on media reactions to the portions. These media reactions can be of a particular group, which may be selected in the request, though this is not required. Further, these media reactions can be determined based on passive sensor data sensed during presentation of the other media program to the persons in the group.

The portions determined for use are based on the group and the media reactions associated with each portion. In some embodiments, highlighting module 220 selects portions from the selected program based on the groups' media reactions being a certain state, interest level, or engagement. Thus, highlighting module 220 may build into the media program that highlights The Godfather a scene in which at least 40% of the persons in the demographic group had a very high interest level (e.g., as shown in FIG. 5).

Highlighting module 220 may base the determination also on information about the media program. Thus, highlighting module 220 may select portions where the media reactions indicate cheering for a sports program, laughing for a comedy program, singing along for a song program, and high engagement or interest for a drama program. In so doing, a particular media reaction or type thereof is relied on in selecting the portions, though this is not required. A weighting of media reactions, such as some persons smiling being included but weighted less than laughing, may also or instead be performed. Further, highlighting module 220 may select portions based on a majority or other relative number of the group having a particular media reaction.

Block 704 may also select or otherwise determine persons belonging to the group as part of determining the portions. As noted elsewhere herein, similarities between persons and the user may be known or determined by the techniques, such as persons that have similar reaction histories, and thus similar tastes. The group, whether explicitly selected by the user or otherwise, may be a group based on demographics, a common attribute or preference between the persons of the group and the user, or some other grouping attribute, like being in a same house, family, or social-networking group. Example common attributes or preferences may also be program-specific, such as a user making the request for highlights to a basketball game between Stanford University and Duke University. Assuming that highlighting module 220 knows or can determine that the user making the request is a fan of Duke Basketball, highlighting module 220 may select persons that have watched the basketball game between Stanford and Duke and either indicated that they are fans of Duke or who are determined to be fans of Duke based on their cheering when Duke's basketball team scores.

Block 706 builds the requested media program using the determined portions of the other media program. As noted above, the requested media program may also include a request for its length, such as four minutes of a half-hour comedy or three songs from a thirty-song double album. Or highlight module 220 may determine the length of the requested media program based on the length of the media program being highlighted, the quality of the media reactions to the portions, the range of different types of media reactions, and so forth. Thus, block 706 may build the requested media program using fewer than all of the determined portions, such as the four best minutes of the comedy when the determined portions would instead be nine minutes long.

Block 706 may also, in conjunction with or similarly to as set forth in one or more parts of methods 800, augment the requested media program with one or more of the media reactions of the persons of the group.

Block 708 provides the requested media program highlighting the other media program. Concluding the movie example above, assume that highlighting module 220 renders, one-at-a-time, the four media programs highlighting four movies, The Lord of the Rings, A Fist-Full of Dollars, A Room with a View, and The Godfather, within the user interface from which the movies can be downloaded or watched. Assume that based on the shorter length and fewer highlights of A Room with a View, that the program highlighting this movie is only three-minutes long. Conversely, assume that based on the quality of the media reactions (e.g., high interest levels, high percentage of persons' having states determined to indicate a high quality, like laughing at a comedy scene or screaming in a thriller), that the programs highlighting The Lord of the Rings, A Fist-Full of Dollars, and The Godfather are twelve, nine, and 14-minutes long, respectively. After watching the highlights, the user selects to watch the whole movie entitled The Godfather.

Methods for Augmenting a Media Program

As noted above, the techniques may augment a media program with prior media reactions to that media program. A media program may be augmented as may highlights of the media program. Thus, highlighting and augmenting may be performed separately or in conjunction.

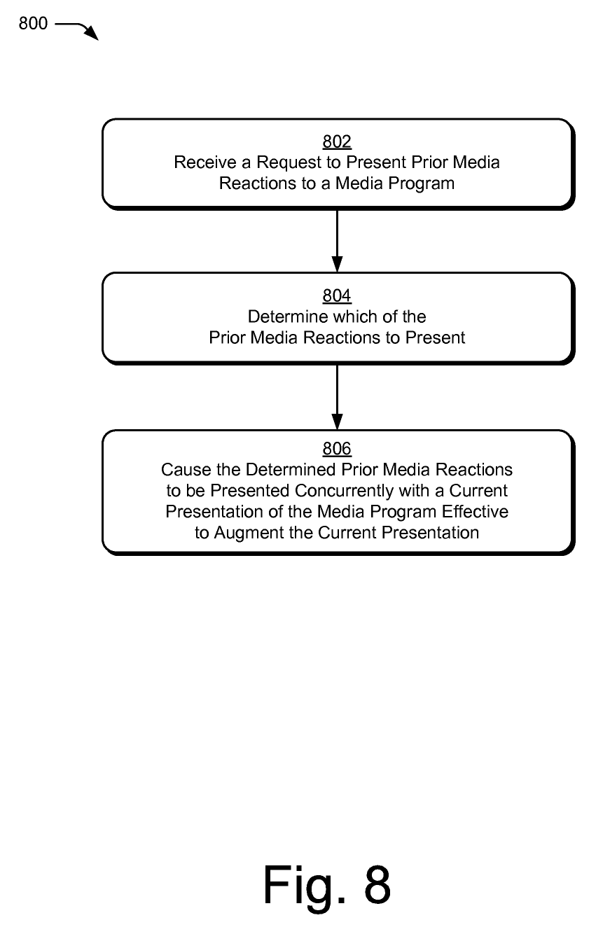

FIG. 8 depicts methods 800 for augmenting a media program with prior media reactions. Block 802 receives a request to present prior media reactions to a media program, the prior media reactions determined based on passive sensor data sensed during one or more prior presentations of the media program.

Block 802 may receive the request prior to or during a current presentation of the media program. Thus, a user may request a program to include augmentations without the program first or currently being presented. In other cases, a user may request a current presentation of the program include prior media reactions. The request may be enabled in various manners, such as selecting a control on a screen (e.g., through user interface 112 of FIG. 1), a button on a remote control, or through a media reaction, such as waving both hands with or without an explicit request for this media reaction.

Consider, for example, a user watching a comedy and being presented with an explicit request to perform a media reaction, such as “If you would like to augment this show with your friend's reactions, please raise your hand.” If the user raises his hand, augmenting module 222 receives this request and the desired group from which to determine media reactions—the user's friends.

This request may include a group differentiator, such as the user's friends, family, a demographic group, and so forth, though methods 800 may forgo determining media reactions based on an explicitly indicated group as well.

Block 804 determines which prior media reactions to present. Block 804 may determine which reactions to present based on various factors. Reactions that are likely to enhance the viewing of a user, for example, can be determined based on factors including the type of the program or information about the user. Augmenting module 222 may determine to present audio of a person laughing to a comedy rather than audio of a person booing or talking during the comedy, as booing and talking are less likely to enhance the user's enjoyment of the comedy. Further, augmenting module 222 may determine, based on the user's reaction history 218, that the user enjoys screaming during a suspense program, and therefore determines to present audio of screaming reactions.

Furthermore, augmenting module 222 may determine which of the prior media reactions to present to augment the media program based on a group. Thus, a user may select his or her social-networking group or a best friend, for example. This group can be identified with a group differentiator, which may then be used by block 804 to select media reactions from those of the group for which media reactions have previously been determined. Augmenting module 222 may instead determine which group from which to use media reactions, such as a group having a shared attribute with the user (e.g., fan of the same team, a family member, a demographic, etc.).

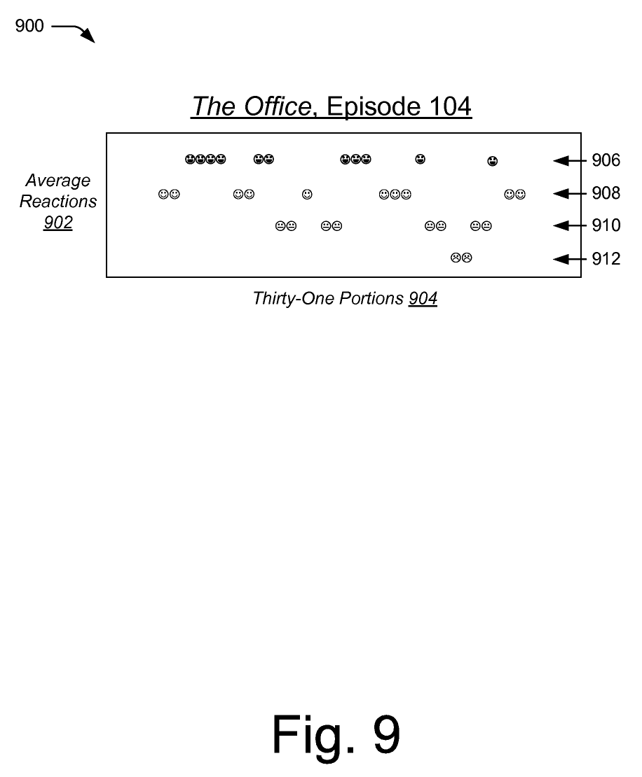

Consider, by way of example, FIG. 9, which illustrates a reaction graph 900 showing average (median) media reactions 902 for a user's friends over thirty-one portions 904 of a program. Here assume that the user is a 14-year-old girl named Bethany, and that she has a group of 34 friends through a social-networking service. Assume that either she selected this group explicitly or augmenting module 222 selected the group for her. In either case, assume that the program is The Office, Episode 104, and that Bethany wants to watch it online through her tablet computing device 202-2 of FIG. 2 two hours after the first airing of The Office, Episode 104 and requests that the program be augmented with media reactions of her friends.

Here augmenting module 222 is operating remotely, as shown in FIG. 3, and receives the request from a streaming-media third-party entity capable of providing media based on a subscription or per-use fee. Augmenting module 222 then determines, using a group differentiator for Bethany's group of friends, media reactions of the group from a pool of media reactions previously recorded for the program, such as many thousands of reactions for many thousands of viewers. With the group's reactions determined, augmenting module 222 also determines that 13 of the 34 friends have seen The Office, Episode 104 and for which media reactions have been retained. Based on these 13 friends' reactions, augmenting module 222 determines average (median) media reactions for 31 portions of the program, though a program may have many more reactions, such as many hundreds or even thousands of portions for a program. As illustrated, four average reactions 902 are determined based on media reactions being states received by augmenting module 222 from state module 106 and for Bethany's friends. These four reactions are laughing 906 (shown with “ [symbol] ”), smiling 908 (shown with “ [symbol] ”), interested 910 (shown with “ [symbol] ”), and departed 912 (shown with “ [symbol] ”).

Based on the program being a comedy and for the group, augmenting module 222 determines to present average reactions 902 throughout presentation of the comedy to Bethany. Thus, augmenting module 222 determines to renders an avatar over a region of the user interface in which the comedy is also rendered that laughs during the 11 portions of thirty-one portions 904 in which the average reaction is laughing 906 and so forth.

Augmenting module 222 may forgo presenting reactions that are unlikely to improve the user's experience or are not the average reaction for the portion, such as when two of Bethany's friends left the room while most of her other friends were laughing. In this case, augmenting module 222 determines not to render an avatar for the two friends that were departed when the other nine friends laughed.

For the other of the average reactions 902, namely smiling 908, interested 910, and departed 912, augmenting module 222 determines to present an avatar smiling during the median smiling states, looking forward without expression during the interested states, and turning its face to show a back of the avatar's head during the departed states.

Block 806 causes the determined prior media reactions to be presented concurrently with a current presentation of the media program effective to augment the current presentation of the media program with the determined prior media reactions. In so doing, augmenting module 222 may present one or more avatars approximating a physical representation of one or more of the determined prior media reactions, such as a person jumping up and down, looking shocked, laughing, and so forth. Augmenting module 222 may also or instead render audio of a person associated with at least one of the determined prior media reactions, such as a clearest or loudest laugh (or some subset of those that laughed) of Bethany's friends that laughed during a particular portion of The Office, Episode 104.

Concluding the ongoing example, augmenting module 222 presents an avatar during presentation of The Office, Episode 104 on Bethany's tablet computing device 202-2 and in user interface 112 that represents the reactions of some of Bethany's friends.

Note that methods 800 may cause presentation of audio, a visual avatar with or without audio, and so forth to augment presentation of a media program. In some embodiments augmenting module 222 builds an audio or visual media reaction program, the audio or visual media reaction program tailored to portions of the media program during which the determined prior media reactions were made. Augmenting module 222 may also render the audio or visual media reaction program with, within, or concurrently with the current presentation of the media program. As noted above, methods 700 and 800 may operate in conjunction in whole or in part. For example, highlighting module 220 may build a four-minute media program with half of the portions in which the average reactions 902 were laughing 906 and augmenting module 222 may augment this four-minute media program with audio and/or visual representations of the media reactions, such as with a laughing avatar or actual video of one or more of Bethany's friends laughing.

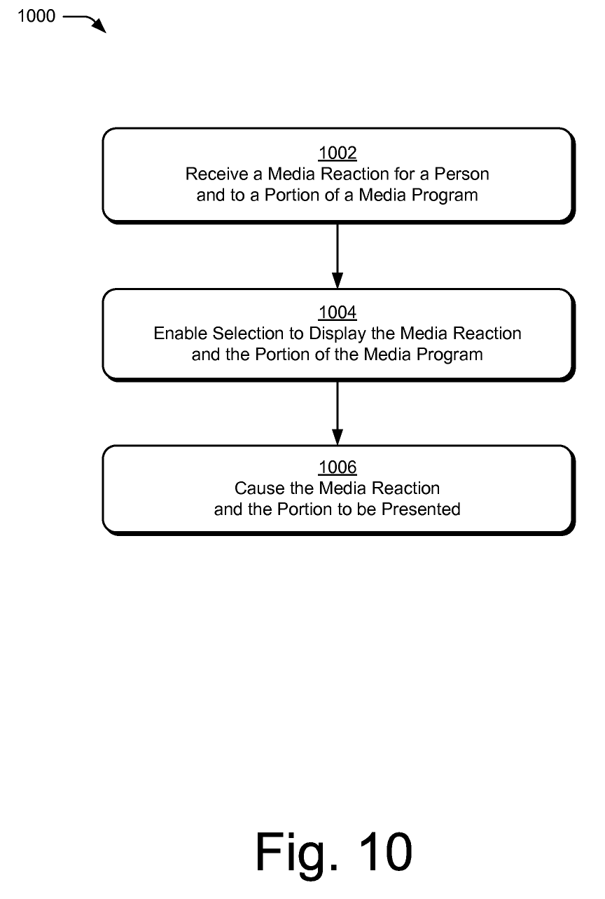

As noted above, methods 800 may act responsive to a request, which may be received in various ways. In some embodiments, this request is enabled through selection in a user interface. FIG. 10 depicts methods 1000 enabling a selection to display a media reaction along with the portion of a media program through a user interface. Methods 1000 may operate prior to or in conjunction with methods 800 or may operate separately.

Block 1002 receives a media reaction for a person, the media reaction determined based on sensor data passively sensed during presentation of a portion of a media program to the person. Ways in which a media reaction is determined are set forth in detail elsewhere herein. The entity receiving the media reaction may, in some cases, be augmenting module 222 or interface module 110 or its user interface 112, which may in turn operate remote from an entity that receives the sensor data and/or determines the media reaction (e.g., audience-sensing device 104 and state module 106). Further, augmenting module 222 or interface module 110 may work in conjunction with other entities, such as a webpage offering a social-networking service.

Block 1004 enables selection to display the media reaction and the portion of the media program. Block 1004 may operate through augmenting module 222 and/or interface module 110, which may enable selection through various manners, such as a social-networking webpage.

Consider for example, a social-networking webpage having an option to enable presentation of a user's audio and video laughing at a joke in a comedy program, dancing during a song, or cheering during a winning soccer goal. The techniques permit such a selection. In some cases this selection is made by the user associated with the media reaction, though instead it may be by another person given access to the user's media reaction. Thus, assume that Bethany watches The Office, Episode 104, and during that program laughs at a particular scene in the program. The techniques enable Bethany or Bethany's friends to select to see (in actual or avatar form) and hear that laugh along with the scene.

Block 1006, responsive to selection, causes the media reaction and the portion of the media program to be presented. Block 1006 may operate similarly to as set forth in methods 800, such as to present a media reaction along with presentation of a media program and at the corresponding portion. Block 1006 may instead present only a portion, such as a 30-second part of a soccer game showing a goal along with a user's reaction to it. Further, this reaction and presentation does not need to be through a television-like presentation. It may instead be presented in various manners, such as on selection of a control in a social-networking webpage in response to which the media reaction and the portion are shown.

The preceding discussion describes methods relating to highlighting or augmenting a media program, as well as other methods and techniques. Aspects of these methods may be implemented in hardware (e.g., fixed logic circuitry), firmware, software, manual processing, or any combination thereof. A software implementation represents program code that performs specified tasks when executed by a computer processor. The example methods may be described in the general context of computer-executable instructions, which can include software, applications, routines, programs, objects, components, data structures, procedures, modules, functions, and the like. The program code can be stored in one or more computer-readable memory devices, both local and/or remote to a computer processor. The methods may also be practiced in a distributed computing mode by multiple computing devices. Further, the features described herein are platform-independent and can be implemented on a variety of computing platforms having a variety of processors.

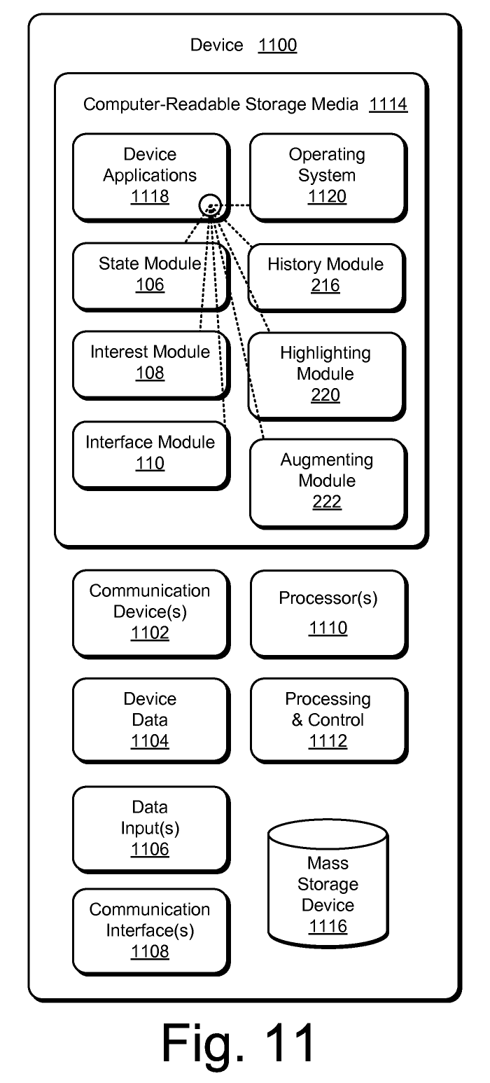

These techniques may be embodied on one or more of the entities shown in FIGS. 1-3 and 11 (device 1100 is described below), which may be further divided, combined, and so on. Thus, these figures illustrate some of many possible systems or apparatuses capable of employing the described techniques. The entities of these figures generally represent software, firmware, hardware, whole devices or networks, or a combination thereof. In the case of a software implementation, for instance, the entities (e.g., state module 106, interest module 108, interface module 110, history module 216, highlighting module 220, and augmenting module 222) represent program code that performs specified tasks when executed on a processor (e.g., processor(s) 204 and/or 306). The program code can be stored in one or more computer-readable memory devices, such as CRM 206, remote CRM 308, and/or computer-readable storage media 1116 of FIG. 11.

Example Device

FIG. 11 illustrates various components of example device 1100 that can be implemented as any type of client, server, and/or computing device as described with reference to the previous FIGS. 1-10 to implement techniques for highlighting or augmenting a media program. In embodiments, device 1100 can be implemented as one or a combination of a wired and/or wireless device, as a form of television mobile computing device (e.g., television set-top box, digital video recorder (DVR), etc.), consumer device, computer device, server device, portable computer device, user device, communication device, video processing and/or rendering device, appliance device, gaming device, electronic device, System-on-Chip (SoC), and/or as another type of device or portion thereof. Device 1100 may also be associated with a user (e.g., a person) and/or an entity that operates the device such that a device describes logical devices that include users, software, firmware, and/or a combination of devices.

Device 1100 includes communication devices 1102 that enable wired and/or wireless communication of device data 1104 (e.g., received data, data that is being received, data scheduled for broadcast, data packets of the data, etc.). Device data 1104 or other device content can include configuration settings of the device, media content stored on the device (e.g., media programs 210), and/or information associated with a user of the device. Media content stored on device 1100 can include any type of audio, video, and/or image data. Device 1100 includes one or more data inputs 1106 via which any type of data, media content, and/or inputs can be received, such as human utterances, user-selectable inputs, messages, music, television media content, media reactions, recorded video content, and any other type of audio, video, and/or image data received from any content and/or data source.

Device 1100 also includes communication interfaces 1108, which can be implemented as any one or more of a serial and/or parallel interface, a wireless interface, any type of network interface, a modem, and as any other type of communication interface. Communication interfaces 1108 provide a connection and/or communication links between device 1100 and a communication network by which other electronic, computing, and communication devices communicate data with device 1100.

Device 1100 includes one or more processors 1110 (e.g., any of microprocessors, controllers, and the like), which process various computer-executable instructions to control the operation of device 1100 and to enable techniques for highlighting or augmenting a media program and other methods described herein. Alternatively or in addition, device 1100 can be implemented with any one or combination of hardware, firmware, or fixed logic circuitry that is implemented in connection with processing and control circuits which are generally identified at 1112. Although not shown, device 1100 can include a system bus or data transfer system that couples the various components within the device. A system bus can include any one or combination of different bus structures, such as a memory bus or memory controller, a peripheral bus, a universal serial bus, and/or a processor or local bus that utilizes any of a variety of bus architectures.

Device 1100 also includes computer-readable storage media 1116, such as one or more memory devices that enable persistent and/or non-transitory data storage (i.e., in contrast to mere signal transmission), examples of which include random access memory (RAM), non-volatile memory (e.g., any one or more of a read-only memory (ROM), flash memory, EPROM, EEPROM, etc.), and a disk storage device. A disk storage device may be implemented as any type of magnetic or optical storage device, such as a hard disk drive, a recordable and/or rewriteable compact disc (CD), any type of a digital versatile disc (DVD), and the like. Device 1100 can also include a mass storage device 1116.

Computer-readable storage media 1116 provides data storage mechanisms to store device data 1104, as well as various device applications 1118 and any other types of information and/or data related to operational aspects of device 1100. For example, an operating system 1120 can be maintained as a computer application with computer-readable storage media 1116 and executed on processors 1110. Device applications 1118 may include a device manager, such as any form of a control application, software application, signal-processing and control module, code that is native to a particular device, a hardware abstraction layer for a particular device, and so on.

Device applications 1118 also include any system components, engines, or modules to implement techniques for highlighting or augmenting a media program. In this example, device applications 1118 can include state module 106, interest module 108, interface module 110, history module 216, highlighting module 220, and/or augmenting module 222.

### CONCLUSION

Although embodiments of techniques and apparatuses for highlighting or augmenting a media program have been described in language specific to features and/or methods, it is to be understood that the subject of the appended claims is not necessarily limited to the specific features or methods described. Rather, the specific features and methods are disclosed as example implementations for highlighting or augmenting a media program.

1. A computer-implemented method comprising:
receiving a request for a media program highlighting another media program;
determining which portions of the other media program highlight the other media program based on media reactions of a group of persons, the media reactions of the persons determined based on passive sensor data sensed during presentation of the other media program to the persons;
building the requested media program using the determined portions of the other media program;
augmenting the requested media program with audio from one or more of the media reactions of the group of persons; and
providing the requested media program.

2. A computer-implemented method as described in claim 1, wherein determining which of the portions highlight the other media program is based on the media reactions and information about the other media program.

3. A computer-implemented method as described in claim 2, wherein the information indicates that the other media program is a sporting program and determining which of the portions to use is based on the media reactions being a cheering, booing, or yelling state.

4. A computer-implemented method as described in claim 2, wherein the information indicates that the other media program is a comedy program and determining which of the portions to use is based on the media reactions being a laughing or smiling state.

5. A computer-implemented method as described in claim 1, wherein augmenting the requested media program includes in the requested media program a visual representation of one of the media reactions.

6. A computer-implemented method as described in claim 1, wherein the group is a social networking group in which a user making the request is associated.

7. A computer-implemented method as described in claim 1, wherein the group is defined by an attribute common to the persons in the group and a user making the request.

8. A computer-implemented method comprising:
receiving a request to present prior media reactions to a media program, the prior media reactions having audio and determined based on passive sensor data sensed during one or more prior presentations of the media program;
determining which of the prior media reactions to present; and
causing the audio of one or more of the determined prior media reactions to be presented concurrently with a current presentation of the media program effective to augment the current presentation of the media program with the audio of the one or more of the determined prior media reactions.

9. A computer-implemented method as described in claim 8, wherein determining which of the prior media reactions to present is based on the prior media reactions being of persons of a group.

10. A computer-implemented method as described in claim 9, wherein the group is a social-networking group in which a user making the request is associated.

11. A computer-implemented method as described in claim 9, wherein the group is determined based on a shared attribute of a user making the request.

12. A computer-implemented method as described in claim 8, wherein causing the audio of the one or more of the determined prior media reactions to be presented presents the audio of each of the one or more of the determined prior media reactions concurrently with a portion of the media program during which the passive sensor data on which each of the determined prior media reactions is based was sensed.

13. A computer-implemented method as described in claim 8, wherein causing the audio of the one or more of the determined prior media reactions to be presented further comprises presenting one or more avatars approximating a physical representation of one or more of the determined prior media reactions.

14. A computer-implemented method as described in claim 8, wherein the audio of the one or more prior media reactions further comprises audio of a person associated with at least one of the one or more determined prior media reactions.

15. A computer-implemented method as described in claim 8, wherein the request indicates a group differentiator, the group differentiator sufficient to determine which of the prior media reactions to present based on the prior media reactions being from persons determined to be in a group, the group determined based on the group differentiator.

16. A computer-implemented method as described in claim 8, wherein determining which of the prior media reactions to present builds an audio or visual media reaction program, the audio or visual media reaction program tailored to portions of the media program during which the one or more of the determined prior media reactions were made.

17. A computer-implemented method as described in claim 8, wherein causing the audio of the one or more of the determined prior media reactions to be presented renders the audio or visual media reaction program with, within, or concurrently with the current presentation of the media program.

18. A computer-implemented method as described in claim 8, wherein the media reactions include states, the states including one or more of: a sad, a related talking, an unrelated talking, a disgusted, an afraid, a smiling, a scowling, a placid, a surprised, an angry, a laughing, a screaming, a clapping, a waving, a cheering, a looking-away, a looking-toward, a leaning-away, a leaning-toward, an asleep, or a departed state.

19. A computer-implemented method comprising:
receiving a media reaction for a person, the media reaction having audio and determined based on sensor data passively sensed during presentation of a portion of a media program to the person;
enabling selection to display the media reaction and the portion of the media program; and
responsive to selection, causing the media reaction, including the audio of the media reaction, and the portion of the media program to be presented.

20. A computer-implemented method as described in claim 19, wherein enabling selection is through a social-networking webpage and causing the media reaction and the portion to be presented presents audio or visual data associated with the media reaction along with the portion and through the social-networking webpage.
